(19) United States
(12) Patent Application Publication
(10) Pub. No.: US 2026/0234051 A1
(43) Pub. Date: Aug. 13, 2026

(54) MULTILAYER STRUCTURE FOR LOW-EMISSIVITY GLASS

(71) Applicant: KCC GLASS Corporation, Seoul (KR)

(72) Inventors: Bo-Na YU, Seoul (KR); Chong-Cheol KIM, Yongin (KR); Seok KIM, Pyeongtaek (KR)

(21) Appl. No.: 19/152,004

(22) PCT Filed: Jan. 9, 2024
(86) PCT No.: PCT/KR2024/000422

§ 371 Date: Jul. 30, 2025

(30) Foreign Application Priority Data
Feb. 6, 2023 (KR) 10-2023-0015750

(51) Int. Cl. C03C 17/36

(52) U.S. Cl. CPC C03C 17/366; C03C 17/3613; C03C 17/3634; C03C 17/3642

(57) ABSTRACT

The present disclosure relates to a multilayer structure for low-emissivity glass, which includes a first dielectric layer, a first metal protecting layer, a first infrared ray reflecting layer, a second metal protecting layer, a second dielectric layer, a dielectric protecting layer, and an overcoat layer, sequentially, in which the overcoat layer includes a carbon layer.

### TECHNICAL FIELD

The present disclosure relates to a multilayer structure for low-emissivity glass, which has high visible light transmittance, excellent durability, and excellent thermal insulation performance.

### BACKGROUND ART

The low-emissivity glass is a functional architectural material, which maintains the transparency of the glass, blocks indoor heating energy from leaking to the outside during winter, and reflects solar radiant heat entering indoors during summer, by depositing a metal, such as silver (Ag), having high reflectance in the infrared region on the transparent glass. The low-emissivity glass is initially used in a limited manner for non-residential buildings having a large area for placing glass. However, as the necessity for energy saving has recently been increased, application cases to residential buildings are also increasing.

The low-emissivity glass applied to the residential buildings is required to have a high visible light transmittance for viewing comfort. In contrast, the low-emissivity glass applied to non-residential buildings is required to have excellent thermal insulation, shielding performance, and an elegant appearance, instead of the high visible light transmittance. In addition, since the low-emissivity glass applied to the residential buildings is used in larger amounts when compared to that used for the non-residential buildings, it is necessary to additionally secure durability appropriate to usage by many processing agents.

The low-emissivity glass is classified into soft low-e glass and hard low-e glass according to manufacturing manners. Specifically, the hard low-e glass is manufactured through an atmospheric pressure chemical vapor deposition process, and the soft low-e glass is manufactured through a sputtering process. The hard low-e glass includes an oxide film generated at a high temperature in the form of a coating film. Accordingly, the hard low-e glass allows after-hardening and is easy to handle. However, the hard low-e glass is inferior in thermal insulation and shielding performance due to the low electrical conductivity of the coating film, when compared to thermal insulation and shielding performance of the soft low-e glass.

Meanwhile, the soft low-e glass typically includes a metal layer having excellent electrical conductivity and dielectric layers provided on and under the metal layer to protect the metal layer. Specifically, Korean Patent Registration No. 1979625 (Patent Document 1) discloses a low-emissivity coating which includes a first dielectric layer including silicon-aluminum nitride, a low-emissivity layer, and a second dielectric layer including silicon-aluminum nitride, in which each of the first and second dielectric layers is formed in the form of a sputtering target by depositing silicon-aluminum, under a reactive gas atmosphere. However, when a dielectric layer is deposited on the low-emissivity layer including a metal as in Patent Document 1, since a metal is used as a target material under an oxygen or nitrogen atmosphere, the metal layer is oxidized or nitrided by oxygen or nitrogen introduced into the chamber. Accordingly, a boundary between the metal layer and the dielectric layer becomes indistinct. Accordingly, emissivity is increased and the characteristics of the low-emissivity glass are lost.

Accordingly, there has been required research and development for low-e glass, which has the excellent visible light transmittance of at least 50% and the excellent durability appropriate to application to the residential buildings.

### PRIOR ART DOCUMENTS

### Patent Documents

(Patent Document 1) Korean Patent Registration No. 1979625 (Publication Date: Jan. 27, 2016)

### DISCLOSURE OF THE INVENTION

### Technical Problem

As described above, the present disclosure is to provide a multilayer structure for low-emissivity glass, which exhibits the high visible light transmittance of at least 50%, thereby providing excellent viewing comfort, excellent insulation performance, excellent sunlight shielding performance, and excellent durability, which is applicable to residential buildings.

### Technical Solution

According to the present disclosure, there is provided a multilayer structure for low-emissivity glass, which sequentially includes a first dielectric layer, a first metal protecting layer, a first infrared ray reflecting layer, a second metal protecting layer, a second dielectric layer, a dielectric protecting layer and an overcoat layer.

The overcoat layer includes a carbon layer.

### Advantageous Effects

As described above, according to the present disclosure, the multilayer structure for low-emissivity glass exhibits the high visible light transmittance of at least 50%, thereby providing excellent viewing comfort, and excellent durability. Accordingly, the multilayer structure for low-emissivity glass exhibits excellent mechanical properties such as scratch resistance and heat resistances. In addition, the multilayer structure for low-emissivity glass has low emissivity, thereby providing excellent sunlight shielding performance and excellent insulation performance. Accordingly, the multilayer structure for low-emissivity glass is applicable to a building material for residential buildings.

### BRIEF DESCRIPTION OF DRAWINGS

FIGS. 1 and 2 are cross-sectional views illustrating a multilayer structure for low-emissivity glass according to an embodiment of the present disclosure.

### MODE FOR CARRYING OUT THE INVENTION

Hereinafter, the present disclosure will be described in detail.

In this specification, a certain part includes a certain component, which means that the certain part may further include another component, instead of excluding the another component, unless otherwise specified.

In this specification, a certain member is “on” another member, which means that the certain member may make contact with the another member or still another member may be interposed between the certain member and the another member.

Furthermore, in this specification, a “refractive index” refers to a refractive index value measured at a wavelength of 550 nm using a spectroscopic ellipsometer.

In this specification, an “a* value” and “b* value” of glass means the a* value and b* value of a glass surface measured in compliance with the standard of KS L 2514 using a D65 standard light source in a wavelength ranging from 380 nm to 780 nm, based on an average glass substrate thickness of 6 mm.

The multilayer structure for low-emissivity glass according to the present disclosure sequentially includes a first dielectric layer, a first metal protecting layer, a first infrared ray reflecting layer, a second metal protecting layer, a second dielectric layer, a dielectric protecting layer, and an overcoat layer.

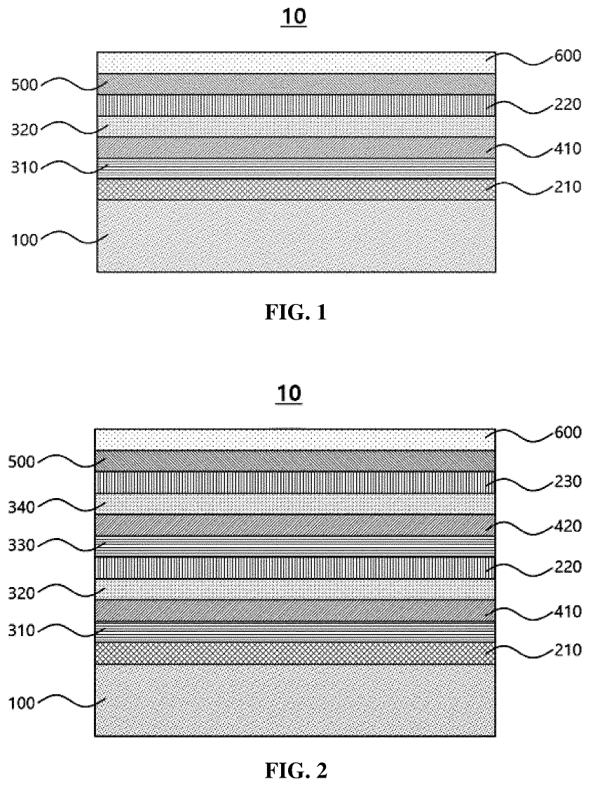

For example, the multilayer structure for low-emissivity glass may further include a glass substrate under the first dielectric layer. Specifically, referring to FIG. 1, a multilayer 10 structure for low-emissivity glass may sequentially include a glass substrate 100, a first dielectric layer 210, a first metal protecting layer 310, a first infrared ray reflecting layer 410, a second metal protecting layer 320, a second dielectric layer 220, a dielectric protecting layer 500, and an overcoat layer 600.

Specifically, the multilayer structure for low-emissivity glass may further sequentially include a third metal protecting layer, a second infrared ray reflecting layer, a fourth metal protecting layer, and a third dielectric layer between the second dielectric layer and the dielectric protecting layer.

Referring to FIG. 2, the multilayer 10 structure for low-emissivity glass may sequentially include the glass substrate 100, the first dielectric layer 210, the first metal protecting layer 310, the first infrared ray reflecting layer 410, the second metal protecting layer 320, the second dielectric layer 220, the third metal protecting layer 330, the second infrared ray reflecting layer 420, the fourth metal protecting layer 340, the third dielectric layer 230, the dielectric protecting layer 500, and the overcoat layer 600.

As described above, the multilayer structure for low-emissivity glass according to the present disclosure includes the dielectric protecting layer and the overcoat layer at an uppermost portion thereto, thereby protecting the dielectric layer and the infrared ray reflecting layer from physical damage and thermal damage, thereby ensuring excellent durability of the low-emissivity glass, such that the performance of the low-emissivity glass may be maintained even after heat treatment. When the multilayer structure for low-emissivity glass does not include the dielectric protecting layer, a haze phenomenon may occur after heat treatment. When the multilayer structure for low-emissivity glass does not include the overcoat layer, scratches may be caused on the surface during handling of the multilayer structure for low-emissivity glass, which causes damage to the infrared ray reflecting layer after heat treatment.

### Glass Substrate

The glass substrate serves as a base substrate for the multilayer structure for low-emissivity glass.

The glass substrate may employ conventional glass, such as soda lime glass, low-iron glass, green float glass, or blue float glass, which is used for architectural or automotive purposes.

In addition, the glass substrate employs glass having an appropriate thickness depending on usage purposes. For example, the glass substrate may employ transparent soda lime glass having an average thickness ranging from 2 to 12 mm, or 5 to 6 mm.

### First to Third Dielectric Layers

Each of the first to third dielectric layers block ions or oxygen transmitted to an infrared ray reflecting layer during heat treatment to control optical properties of the manufactured glass.

Each of the first to third dielectric layers may independently include at least one selected from a metal nitride, a metal oxide, or a metal oxynitride. Specifically, each of the first to third dielectric layers may independently include a silicon-containing nitride.

In addition, each of the first to third dielectric layers may independently have a multilayer structure including at least one dielectric layer laminated. Specifically, each of the first to third dielectric layers may independently have a multilayer structure in which one to three dielectric layers are laminated.

Furthermore, the metal contained in each of the first to third dielectric layers may independently include at least one selected from zinc (Zn), titanium (Ti), silicon (Si), niobium (Nb), tin (Sn), aluminum (Al), zirconium (Zr), tantalum (Ta), or the alloy thereof.

More specifically, each of the first to third dielectric layers may independently include SiAlNx or SiZrNx, in which ‘x’ may range from 0.5 to 1.5, or may be greater than 0.5 and less than 1.4.

When each of the first to third dielectric layers independently includes SiAlNx or SiZrNx and ‘x’ falls within the above range, a dielectric layer without metal may be formed, thereby achieving the target properties of the low-emissivity glass. When ‘x’ falls outside the above range, a dielectric layer containing metal may be formed. Accordingly, the visible light transmittance may be decreased, or another color may be implemented instead of a target color.

Each of the first to third dielectric layers may independently have a refractive index of at least 1.8, ranging from 1.8 to 2.5, or ranging from greater than 1.8 and less than 2.3. In addition, each of the first to third dielectric layers may independently have an absorption coefficient of at most 0.1, or ranging from greater than 0 and at most 0.1. When the refractive index and the absorption coefficient of each of the first to third dielectric layers fall within the above ranges, the visible light transmittance of the manufactured glass may be reduced and viewing comfort may be impaired

Furthermore, each of the first to third dielectric layers may independently have an average thickness ranging from 10 to 100 nm, ranging from 20 to 80 nm, or ranging from 30 to 60 nm. When the average thickness of each of the first to third dielectric layers falls within the above range, durability of the manufactured glass may be prevented from being degraded and a surface color may be prevented from being different from the target color. When the average thickness of each of the first to third dielectric layers is less than the above range, the durability of the manufactured glass may be degraded. When the thickness exceeds the above range, the visible light transmittance of the manufactured glass may be reduced.

### First Metal Protecting Layer, Second Metal Protecting Layer, Third Metal Protecting Layer, and Fourth Metal Protecting Layer.

Each of the first metal protecting layer, the second metal protecting layer, the third metal protecting layer, and the fourth metal protecting layer is interposed between the infrared ray reflecting layer and a dielectric layer, thereby improving adhesion force and blocking the migration of Na diffused from the glass and oxygen (O₂) in the air, during heat treatment, and the migration of oxygen (O₂) diffused in the step for depositing the dielectric layer. In addition, each of the first metal protecting layer, the second metal protecting layer, the third metal protecting layer, and the fourth metal protecting layer functions to help the fusion of the metal in the infrared ray reflecting layer such that the infrared ray reflecting layer is stable even at a high heat treatment temperature, and also functions to absorb oxygen (O₂) penetrating into the infrared ray reflecting layer, thereby help maintain the low-emissivity performance of the glass.

Each of the first metal protecting layer, the second metal protecting layer, the third metal protecting layer, and the fourth metal protecting layer may independently include at least one selected from nickel (Ni), chromium (Cr), or a nickel-chromium (Ni—Cr) alloy. Specifically, each of the first metal protecting layer, the second metal protecting layer, the third metal protecting layer, and the fourth metal protecting layer may independently include a nickel-chromium (Ni—Cr) alloy. When each of the first metal protecting layer, the second metal protecting layer, the third metal protecting layer, and the fourth metal protecting layer includes a nickel-chromium (Ni—Cr) alloy, each metal protecting layer may exhibit low reactivity to reactive gas and may effectively block reactive gas flowing into the infrared ray reflecting layer. In contrast, when each of the first to fourth metal protecting layers independently includes a metal and/or alloy other than the types described above, haze may occur due to problems such as oxygen diffusion after heat treatment.

In this case, the nickel-chromium (Ni—Cr) alloy may include 75 to 85 wt % of nickel and 15 to 25 wt % of chromium, based on the total weight of the alloy. When the content of nickel and chromium in the nickel-chromium (Ni—Cr) alloy falls within the above range, a hard metal protecting layer may be formed and the deposition rate of the film may be increased, thereby effectively protecting the infrared ray reflecting layer.

Furthermore, the number of metal protecting layers may be varied depending on the number of infrared ray reflecting layers. For example, when ‘n’ infrared ray reflecting layers are included, ‘n’ or ‘2n’ metal protecting layers may be used. When the number of metal protecting layers is less than ‘n’, durability of the manufactured glass may be degraded and haze in the coating film may be caused after heat treatment and bending processes.

Each of the first metal protecting layer, the second metal protecting layer, the third metal protecting layer, and the fourth metal protecting layer may independently have a thickness ranging from 1 to 7 nm or 1 to 5 nm. When the average thickness of each metal protecting layer falls within the above range, durability of the manufactured glass may be prevented from being degraded and haze in the coating film may be prevented from being increased, after heat treatment and bending processes. When the thickness of each of the first metal protecting layer, the second metal protecting layer, the third metal protecting layer, and the fourth metal protecting layer is less than the above range, the durability of the manufactured glass may be degraded and haze in the coating film may be caused after heat treatment and the bending processes. When the thickness exceeds the above range, the visible light transmittance of the manufactured glass may be reduced and haze in the coating film may be caused after heat treatment and bending processes.

### First Infrared Ray Reflecting Layer and Second Infrared Ray Reflecting Layer

Each of the first infrared ray reflecting layer and the second infrared ray reflecting layer functions to selectively reflect solar radiation, thereby improving the solar heat shielding performance of the manufactured glass while implementing low-emissivity.

Each of the first infrared ray reflecting layer and the second infrared ray reflecting layer may independently include a metal having excellent electrical conductivity and may include at least one metal selected from gold, silver, platinum, aluminum, or copper. Specifically, each of the first infrared ray reflecting layer and the second infrared ray reflecting layer may include silver (Ag). More specifically, each of the first infrared ray reflecting layer and the second infrared ray reflecting layer may consist of silver.

In addition, the average thickness of each of the first infrared ray reflecting layer and the second infrared ray reflecting layer may independently ranges from 10 to 30 nm or 11 to 25 nm. When the thickness of each of the first infrared ray reflecting layer and the second infrared ray reflecting layer falls within the above range, insufficient low-emissivity performance and insufficient thermal insulation performance may be prevented from being caused as the infrared ray reflecting layers are incompletely formed, and durability may be prevented from being degraded due to oxidation of the metal in the infrared ray reflecting layers. When the thickness of each of the first infrared ray reflecting layer and the second infrared ray reflecting layer is less than the above range, insufficient low-emissivity performance and insufficient thermal insulation performance of the manufactured glass may be caused. When the thickness of each of the first infrared ray reflecting layer and the second infrared ray reflecting layer exceeds the above range, durability of the manufactured glass may be degraded.

### Dielectric Protecting Layer

The dielectric protecting layer functions to protect the dielectric layer and the infrared ray reflecting layer.

The dielectric protecting layer may include a material having high mechanical strength, low surface roughness, and the high visible light transmittance. For example, the dielectric protecting layer may include at least one selected from a metal oxide, a metal nitride, or a metal oxynitride. In this case, the metal included in the dielectric protecting layer may include an oxide, a nitride, or an oxynitride of at least one type metal selected from silicon (Si), niobium (Nb), titanium (Ti), zirconium (Zr), or tantalum (Ta). Specifically, the dielectric protecting layer may include titanium. More specifically, the dielectric protecting layer may include a titanium nitride or a titanium oxynitride.

In this case, the titanium oxynitride may be represented by TiOₐN_{b}, in which ‘a’ may range from 0.9 to 1.0 or range from 0.990 to 0.997, and ‘b’ may range from 0.2 to 0.5 or range from 0.3 to 0.4. When ‘a’ falls within the above range, durability of the manufactured glass may be prevented from being degraded. When ‘b’ falls within the above range, the visible light transmittance of the manufactured glass may be prevented from reduced.

In addition, the dielectric protecting layer may have an average thickness ranging from 0.5 to 5 nm or ranging from 1 to 3 nm. When the average thickness of the dielectric protecting layer falls within the above range, durability of the manufactured glass may be prevented from being degraded and haze after heat treatment may be prevented. When the average thickness of the dielectric protecting layer is less than the above range, the durability of the manufactured glass may be degraded. When the thickness exceeds the range, haze may be caused in the manufactured glass after heat treatment.

### Overcoat Layer

The overcoat layer functions to protect the dielectric protecting layer from physical damage and thermal damage. The overcoat layer includes a carbon layer.

Conventionally, the overcoat layer including an oxide or a nitride of an alloy is used. In this case, physical damage to a lower layer may be caused due to external impact before heat treatment, and thermal damage may be caused to the lower layer during heat treatment. However, the present disclosure includes the carbon layer as the overcoat layer, such that the overcoat layer absorbs external impact due to the low hardness of the overcoat layer, thereby preventing the physical damage to the lower layer. In addition, the overcoat layer is sacrificed due to the thermal damage in the process of heat treatment, thereby protecting the dielectric layer, the metal protecting layer, and the infrared ray protecting layer.

The overcoat layer has low visible light transmittance before heat treatment. However, the overcoat layer is completely removed after heat treatment and does not affect optical properties. For example, the carbon layer may include carbon atoms forming carbon-carbon bonds, and may be formed through a sputtering manner.

In addition, the average thickness of the overcoat layer may range from 1 to 10 nm or 1 to 5 nm. When the average thickness of the overcoat layer falls within the above range, durability of the manufactured glass may be prevented from being degraded and the visible light transmittance may be prevented from being reduced. When the average thickness of the overcoat layer is less than the above range, the infrared ray reflecting layer may be damaged, to reduce thermal insulation performance of the manufactured glass. When the average thickness of the overcoat layer exceeds the range, the visible light transmittance of the manufactured glass may be reduced, or the overcoat layer may not be completely removed after heat treatment. Accordingly, the target color may not be obtained.

The multilayer structure for low-emissivity glass according to the present disclosure may have an emissivity of 0.2 or less, or 0.1 or less, as measured in compliance with KS L 2525.

In addition, the multilayer structure for low-emissivity glass may have a visible light transmittance of at least 50% or ranging from 50% to 100% at a wavelength ranging from 380 to 780 nm, as measured in compliance with KS L 2514.

The multilayer structure for low-emissivity glass may have an emissivity of 0.2 or less, or 0.1 or less. The emissivity refers to a ratio of energy which is re-emitted or reflected from the surface after absorbing external light energy, and the maximum value is 1. A smaller emissivity value indicates that the ratio of re-emitted or reflected energy is increased.

As described above, the multilayer structure for low-emissivity glass according to the present disclosure has high visible light transmittance of at least 50%, thereby providing excellent viewing comfort, and excellent durability, to exhibit excellent mechanical properties such as scratch resistance and heat resistance. In addition, the multilayer structure for low-emissivity glass has low emissivity, to exhibit excellent sunlight shielding performance and excellent thermal insulation performance. Accordingly, the low-emissivity glass becomes suitable as an architectural material for residential buildings.

The multilayer structure for low-emissivity glass according to the present disclosure may be manufactured through a magnetron sputtering manner serving as a thin film forming manner for forming each layer. In other words, a method for manufacturing low-emissivity glass according to the present disclosure may include forming each layer through a magnetron sputtering deposition manner.

Hereinafter, the present disclosure is described in more detail through embodiments. However, these embodiments are provided for the understanding of the present disclosure and are not intended to limit the scope of the present disclosure in any way.

### Embodiment

### Experimental Example 1: Fabrication of Multilayer Structure for Low-Emissivity Glass

A multilayer structure for low-emissivity glass was manufactured in a structure in which a glass substrate, a first dielectric layer, a first metal protecting layer, a first infrared ray reflecting layer, a second metal protecting layer, a second dielectric layer, a dielectric protecting layer, and an overcoat layer were sequentially stacked, while the thickness and composition of each layer were adjusted as shown in Table 1.

Specifically, the first dielectric layer was coated on a transparent glass substrate having a thickness of 5 mm using a SiZr target under a nitrogen and argon atmosphere. Then, the first metal protecting layer was coated on the first dielectric layer using a Ni₈Cr₂ target under an argon atmosphere. Subsequently, the first infrared ray reflecting layer was coated on the first metal protecting layer using an Ag target under an argon atmosphere. The second metal protecting layer was coated in the same manner as the first metal protecting layer described above, and the second dielectric layer was coated in the same manner as the first dielectric layer, except that a SiAl target was used.

Then, the dielectric protecting layer was coated on the second dielectric layer using a titanium (Ti) target under an atmosphere of argon, oxygen, and nitrogen. Thereafter, the overcoat layer was coated on the dielectric protecting layer using the carbon target under an argon atmosphere.

### Experimental Examples 2 to 11

Multilayer structure for low-emissivity glass were manufactured in the same manner as in Experimental Example 1, except that the thickness and composition of each layer were adjusted as shown in Table 1.

TABLE 1

| | | Experi- | Experi- | Experi- | Experi- | Experi- | Experi- | Experi- | Experi- | Experi- | Experi- | Experi- |
|---|---|---|---|---|---|---|---|---|---|---|---|---|
| | | mental | mental | mental | mental | mental | mental | mental | mental | mental | mental | mental |
| | | exam- | exam- | exam- | exam- | exam- | exam- | exam- | exam- | exam- | exam- | exam- |
| Configuration | | ple 1 | ple 2 | ple 3 | ple 4 | ple 5 | ple 6 | ple 7 | ple 8 | ple 9 | ple 10 | ple 11 |
| Overcoat | Thick- | 1 | 1.5 | 2 | 5 | 1.5 | 0.5 | 1 | 12 | 1 | — | 1 |
| layer | ness | | | | | | | | | | | |
| | (nm) | | | | | | | | | | | |
| | Compo- | Carbon: 100% | | | | | | | | | | |
| | sition | | | | | | | | | | | |
| Dielectric | Thick- | 1.3 | 1.3 | 1.3 | 1.3 | 1.3 | 1.3 | 1.3 | 1.3 | 7 | 1.3 | — |
| protecting | ness | | | | | | | | | | | |
| layer | (nm) | | | | | | | | | | | |
| | Compo- | TiOₐN_{b}(a = 0.99, b = 0.35) | | | | | | | | | | |
| | sition | | | | | | | | | | | |
| Second | Thick- | 37 | 37 | 37 | 37 | 37 | 37 | 37 | 37 | 37 | 37 | 37 |
| dielectric | ness | | | | | | | | | | | |
| layer | (nm) | | | | | | | | | | | |
| | Compo- | SiAlNₓ(0.5 < x < 1.4), | | | | | | | | | | |
| | sition | Refractive index 2.0, Absorption coefficient 0 | | | | | | | | | | |
| Second metal | Thick- | 3.5 | 3.5 | 3.5 | 3.5 | 4 | 3.5 | 0.5 | 3.5 | 3.5 | 3.5 | 3.5 |
| protecting | ness | | | | | | | | | | | |
| layer | (nm) | | | | | | | | | | | |
| | Compo- | NiCr(Ni:Cr = 8:2) | | | | | | | | | | |
| | sition | | | | | | | | | | | |
| First infrared | Thick- | 12 | 12 | 12 | 12 | 12 | 12 | 12 | 12 | 12 | 12 | 12 |
| ray reflecting | ness | | | | | | | | | | | |
| layer | (nm) | | | | | | | | | | | |
| | Compo- | Ag 100% | | | | | | | | | | |
| | sition | | | | | | | | | | | |
| First metal | Thick- | 2.5 | 2.5 | 2.5 | 2.5 | 3 | 2.5 | 0.5 | 2.5 | 2.5 | 2.5 | 2.5 |
| protecting | ness | | | | | | | | | | | |
| layer | (nm) | | | | | | | | | | | |
| | Compo- | NiCr(Ni:Cr = 8:2) | | | | | | | | | | |
| | sition | | | | | | | | | | | |
| First | Thick- | 38.1 | 38.1 | 38.1 | 38.1 | 38.1 | 38.1 | 38.1 | 38.1 | 38.1 | 38.1 | 38.1 |
| dielectric | ness | | | | | | | | | | | |
| layer | (nm) | | | | | | | | | | | |
| | Compo- | SiZrNₓ(0.5 < x < 1.4), | | | | | | | | | | |
| | sition | Refractive index: 2.2, Absorption coefficient 0 | | | | | | | | | | |
| Glass | Thick- | 5 | 5 | 5 | 5 | 5 | 5 | 5 | 5 | 5 | 5 | 5 |
| substrate | ness | | | | | | | | | | | |
| | (nm) | | | | | | | | | | | |

### Experimental Example 12

Low-emissivity glass was manufactured in the same manner as in Experimental Example 1, except that a third metal protecting layer was formed on the second dielectric layer in the same manner as the second metal protecting layer, a second infrared ray reflecting layer was formed on the third metal protecting layer in the same manner as the first infrared ray reflecting layer, a fourth metal protecting layer was formed on the second infrared ray reflecting layer in the same manner as the second metal protecting layer, and a third dielectric layer was formed on the fourth metal protecting layer in the same manner as the second dielectric layer.

### Experimental Examples 13 to 22

Low-emissivity glass was manufactured in the same manner as in Experimental Example 12, except that the thickness and composition of each layer were adjusted as shown in Table 2.

TABLE 2

| | | Experi- | Experi- | Experi- | Experi- | Experi- | Experi- | Experi- | Experi- | Experi- | Experi- | Experi- |
|---|---|---|---|---|---|---|---|---|---|---|---|---|
| | | mental | mental | mental | mental | mental | mental | mental | mental | mental | mental | mental |
| | | exam- | exam- | exam- | exam- | exam- | exam- | exam- | exam- | exam- | exam- | exam- |
| Configuration | | ple 12 | ple 13 | ple 14 | ple 15 | ple 16 | ple 17 | ple 18 | ple 19 | ple 20 | ple 21 | ple 22 |
| Overcoat | Thick- | 1 | 1.5 | 3 | 5 | 1.5 | 0.5 | 3 | 12 | 1 | — | 1 |
| layer | ness | | | | | | | | | | | |
| | (nm) | | | | | | | | | | | |
| | Compo- | Carbon: 100% | | | | | | | | | | |
| | sition | | | | | | | | | | | |
| Dielectric | Thick- | 1.5 | 1.5 | 1.5 | 1.5 | 1.5 | 1.5 | 1.5 | 1.5 | 7 | 1.5 | — |
| protecting | ness | | | | | | | | | | | |
| layer | (nm) | | | | | | | | | | | |
| | Compo- | TiOₐN_{b}(a = 0.99, b = 0.35) | | | | | | | | | | |
| | sition | | | | | | | | | | | |
| | Thick- | 29.3 | 29.3 | 29.3 | 29.3 | 29.3 | 29.3 | 29.3 | 29.3 | 29.3 | 29.3 | 29.3 |
| | ness | | | | | | | | | | | |
| | (nm) | | | | | | | | | | | |
| Third | Compo- | SiAINₓ(0.5 < x < 1.4), | | | | | | | | | | |
| dielectric | sition | Refractive index:: 2.0, Absorption coefficient: 0 | | | | | | | | | | |
| layer | | | | | | | | | | | | |
| Fourth | Thick- | 1.3 | 1.3 | 1.3 | 1.3 | 1.9 | 1.3 | 0.5 | 1.3 | 1.3 | 1.3 | 1.3 |
| metal | ness | | | | | | | | | | | |
| protecting | (nm) | | | | | | | | | | | |
| layer | Compo- | NiCr(Ni:Cr = 8:2) | | | | | | | | | | |
| | sition | | | | | | | | | | | |
| Second | Thick- | 10 | 10 | 10 | 10 | 10 | 10 | 10 | 10 | 10 | 10 | 10 |
| infrared ray | ness | | | | | | | | | | | |
| reflecting | (nm) | | | | | | | | | | | |
| layer | Compo- | Ag 100% | | | | | | | | | | |
| | sition | | | | | | | | | | | |
| Third metal | Thick- | 1.5 | 1.5 | 1.5 | 1.5 | 2.1 | 1.5 | 0.5 | 1.5 | 1.5 | 1.5 | 1.5 |
| protecting | ness | | | | | | | | | | | |
| layer | (nm) | | | | | | | | | | | |
| | Compo- | NiCr(Ni:Cr = 8:2) | | | | | | | | | | |
| | sition | | | | | | | | | | | |
| Second | Thick- | 76.5 | 76.5 | 76.5 | 76.5 | 76.5 | 76.5 | 76.5 | 76.5 | 76.5 | 76.5 | 76.5 |
| dielectric | ness | | | | | | | | | | | |
| layer | (nm) | | | | | | | | | | | |
| | Compo- | SiAlNₓ(0.5 < x < 1.4), | | | | | | | | | | |
| | sition | Refractive index: 2.0, Absorption coefficient: 0 | | | | | | | | | | |
| Second | Thick- | 2.7 | 2.7 | 2.7 | 2.7 | 3.3 | 2.7 | 0.8 | 2.7 | 2.7 | 2.7 | 2.7 |
| metal | ness | | | | | | | | | | | |
| protecting | (nm) | | | | | | | | | | | |
| layer | Compo- | NiCr(Ni:Cr = 8:2) | | | | | | | | | | |
| | sition | | | | | | | | | | | |
| First | Thick- | 22 | 22 | 22 | 22 | 22 | 22 | 22 | 22 | 22 | 22 | 22 |
| infrared ray | ness | | | | | | | | | | | |
| reflecting | (nm) | | | | | | | | | | | |
| layer | Compo- | Ag 100% | | | | | | | | | | |
| | sition | | | | | | | | | | | |
| First metal | Thick- | 2.5 | 2.5 | 2.5 | 2.5 | 3 | 2.5 | 0.7 | 2.5 | 2.5 | 2.5 | 2.5 |
| protecting | ness | | | | | | | | | | | |
| layer | (nm) | | | | | | | | | | | |
| | Compo- | NiCr(Ni:Cr = 8:2) | | | | | | | | | | |
| | sition | | | | | | | | | | | |
| First | Thick- | 47.6 | 47.6 | 47.6 | 47.6 | 47.6 | 47.6 | 47.6 | 47.6 | 47.6 | 47.6 | 47.6 |
| dielectric | ness | | | | | | | | | | | |
| layer | (nm) | | | | | | | | | | | |
| | Compo- | SiZrNx(0.5 < x < 1.4), | | | | | | | | | | |
| | sition | Refractive index: 2.2, Absorption coefficient: 0 | | | | | | | | | | |
| Glass | Thick- | 5 | 5 | 5 | 5 | 5 | 5 | 5 | 5 | 5 | 5 | 5 |
| substrate | ness | | | | | | | | | | | |
| | (nm) | | | | | | | | | | | |

### Test Example 1: Evaluation for Glass Properties

Physical properties were measured for the low-emissivity glass manufactured in the experimental examples using the following manners, and the results are shown in Table 3.

Specifically, the low-emissivity glass manufactured in the experimental examples was heat-treated at 650° C. for 5 minutes and then rapidly cooled before evaluating the physical properties.

### (1) Visible Light Transmittance

The visible light transmittance was obtained by measuring a transmission spectrum in a visible wavelength range (380 to 780 nm) using a spectrophotometer (Lambda 950; a product manufactured by PerkinElmer) and calculating the transmittance according to the KS L 2514 standard.

### (2) Scratch Resistance

After spraying distilled water onto the overcoat layer of the manufactured glass, a nylon brush having a thickness of 0.5 mm was moved back and forth 200 times horizontally across the coated surface of the glass, and the number of scratches formed in the overcoat layer was counted to evaluate scratch resistance.

(3) Heat Resistance (Haze after Heat Treatment)

The manufactured low-emissivity glass was heat-treated at 650° C. for 5 minutes, and the overcoat layer surface was visually observed to determine whether the overcoat layer became hazy to evaluate heat resistance.

### (4) Color Stability (ΔE)

The degree of color difference depending on the thickness of the overcoat layer was evaluated. Specifically, the color of the overcoat layer was measured using a colorimeter (manufactured by Minolta), and the obtained value was calculated in compliance with the standard of KS A 0063 to evaluate the color difference (ΔE) depending on the overcoat layer thickness. In this case, Experimental Examples 1 to 11 employed Experimental Example 1 as a control group, and Experimental Examples 12 to 22 employed Experimental Example 12 as a control group. A lower ΔE value indicates less color difference. According to ASTM C 1376, if a ΔE value is 4.5 or higher, it was determined as having a color difference, and if a ΔE value is less than 4.5, it was determined as having good color stability.

### (5) Sheet Resistance

After heat-treating the manufactured low-emissivity glass at 650° C. for 5 minutes, the sheet resistance was measured using a non-contact sheet resistance meter (manufactured by Suragus) to evaluate thermal insulation performance. A lower sheet resistance value indicates higher thermal insulation performance.

### (6) Chemical Resistance

A chemical resistance test solution (a mixed solution of NaCl (3 wt %), L-histidine hydrochloride (1 wt %), sodium dihydrogen phosphate (1 wt %), and deionized water (Di water; 95 wt %)) was dropped onto the overcoat layer of the manufactured low-emissivity glass using a dropper. The result was then placed at a constant temperature and humidity chamber (relative humidity: 80%, temperature: 30° C.). Thereafter, the overcoat layer of the low-emissivity glass was visually evaluated every hour to determine whether any damage is caused.

TABLE 3

| | | Visible light | Scratch | Heat resistance | Color | Sheet | Chemical |
|---|---|---|---|---|---|---|---|
| | | transmit- | resistance | (haze caused | stability | resistance | resistance |
| | | tance (%) | (number) | or not) | (ΔE) | (Ω/sq.) | (TIME) |
| One | Experimental | 76.5 | 4 | Not caused | — | 7.6 | 24 |
| infrared ray | example 1 | | | | | | |
| reflecting | Experimental | 76.5 | 4 | Not caused | 0.3 | 7.6 | 24 |
| layer | example 2 | | | | | | |
| | Experimental | 76.5 | 4 | Not caused | 0.3 | 7.6 | 24 |
| | example 3 | | | | | | |
| | Experimental | 76.5 | 2 | Not caused | 0.4 | 7.6 | 24 |
| | example 4 | | | | | | |
| | Experimental | 76.3 | 2 | Not caused | 0.4 | 7.6 | 24 |
| | example 5 | | | | | | |
| | Experimental | 76.5 | 8 | Not caused | 0.3 | 8.7 | 24 |
| | example 6 | | | | | | |
| | Experimental | 78.3 | 8 | Caused | 0.3 | 9.5 | 20 |
| | example 7 | | | | | | |
| | Experimental | 73.2 | 5 | Not caused | 5.1 | 7.6 | 6 |
| | example 8 | | | | | | |
| | Experimental | 76.5 | 4 | Caused | 1.1 | 9.0 | 20 |
| | example 9 | | | | | | |
| | Experimental | 76.5 | 15 | Not caused | 0.3 | 8.9 | 24 |
| | example 10 | | | | | | |
| | Experimental | 76.5 | 8 | Not caused | 0.7 | 8.7 | 20 |
| | example 11 | | | | | | |
| Two | Experimental | 50.6 | 5 | Not caused | — | 1.7 | 10 |
| infrared ray | example 12 | | | | | | |
| reflecting | Experimental | 50.6 | 5 | Not caused | 0.4 | 1.7 | 10 |
| layers | example 13 | | | | | | |
| | Experimental | 50.6 | 3 | Not caused | 0.4 | 1.7 | 10 |
| | example 14 | | | | | | |
| | Experimental | 50.6 | 2 | Not caused | 0.6 | 1.7 | 10 |
| | example 15 | | | | | | |
| | Experimental | 50.2 | 2 | Not caused | 0.4 | 1.7 | 10 |
| | example 16 | | | | | | |
| | Experimental | 50.6 | 12 | Not caused | 0.4 | 2.9 | 10 |
| | example 17 | | | | | | |
| | Experimental | 51.2 | 18 | Caused | 0.5 | 4.2 | 8 |
| | example 18 | | | | | | |
| | Experimental | 47.7 | 2 | Not caused | 5.6 | 1.7 | 2 |
| | example 19 | | | | | | |
| | Experimental | 50.6 | 2 | Caused | 1.3 | 3.7 | 10 |
| | example 20 | | | | | | |
| | Experimental | 50.4 | 25 | Not caused | 0.4 | 3.5 | 10 |
| | example 21 | | | | | | |
| | Experimental | 50.6 | 15 | Not caused | 0.7 | 2.9 | 8 |
| | example 22 | | | | | | |

As shown in Table 3, it may be recognized that the low-emissivity glass of Experimental Examples 1 to 5 and 12 to 16 exhibited excellent durability to make a small number of scratches, exhibited excellent chemical resistance to extend resistance time against a chemical solution, and exhibited heat resistance to prevent haze after heat treatment, and exhibited the thermal insulation performance, which was not degraded, to lower sheet resistance.

In contrast, in Experimental Examples 6 and 17, in which the overcoat layer was thin, Experimental Example 7, in which the first metal protecting layer and the second metal protecting layer were thin, Experimental Example 18, in which the first metal protecting layer, the second metal protecting layer, the third metal protecting layers were thin, Experimental Examples 10 and 21, which did not include the overcoat layer, and Experimental Examples 11 and 22, which did not include the dielectric protecting layer, insufficient durability makes a larger number of scratches. In particular, Experimental Examples 6 and 17 exhibited degraded thermal insulation performance after heat treatment, thereby increasing sheet resistance. Experimental Examples 7 and 18 exhibited insufficient heat resistance to cause haze after heat treatment and exhibited degraded thermal insulation performance to increase sheet resistance.

In addition, Experimental Examples 8 and 19, in which the overcoat layer was thick, exhibited insufficient chemical resistance and were easily damaged by chemical solutions. In particular, it may be recognized in Experimental Example 19 that when the thickness of the overcoat layer exceeded a certain level, the optical properties of the low-emissivity glass were affected, thereby reducing light transmittance and deteriorating color stability.

Experimental Examples 9 and 20, in which the dielectric protecting layer was thick, exhibited insufficient heat resistance, to cause haze after heat treatment and exhibited degradation in thermal insulation performance, to increase sheet resistance.

1. A multilayer structure for low-emissivity glass, comprising:
a first dielectric layer, a first metal protecting layer, a first infrared ray reflecting layer, a second metal protecting layer, a second dielectric layer, a dielectric protecting layer, and an overcoat layer, sequentially,
wherein the overcoat layer includes a carbon layer.

2. The multilayer structure of claim 1, wherein each of the first dielectric layer and the second dielectric layer independently includes at least one type selected from a metal nitride, a metal oxide or a metal oxynitride, and
wherein each of the first metal protecting layer and the second metal protecting layer independently includes at least one selected from nickel (Ni), chromium (Cr) or a nickel-chromium (Ni—Cr).

3. The multilayer structure of claim 1, wherein the dielectric protecting layer includes a metal oxide, a nitride, or an oxynitride of at least one type metal selected from the group consisting of silicon (Si), niobium (Nb), titanium (Ti), zirconium (Zr), and tantalum (Ta).

4. The multilayer structure of claim 1, wherein the overcoat layer has an average thickness ranging from 1 to 10 nm,
wherein the dielectric protecting layer has an average thickness ranging from 0.5 to 5 nm,
wherein each of the first dielectric layer and the second dielectric layer independently has an average thickness ranging from 10 to 100 nm,
wherein each of the first metal protecting layer and the second metal protecting layer independently has an average thickness ranging from 1 to 7 nm, and
wherein the first infrared ray reflecting layer has an average thickness ranging from 10 to 30 nm.

5. The multilayer structure of claim 1, further including:
a third metal protecting layer, a second infrared ray reflecting layer, a fourth metal protecting layer, and a third dielectric layer, sequentially, between the second dielectric layer and the dielectric protecting layer.

6. The multilayer structure of claim 1, wherein emissivity of at most 0.2 is measured in compliance with KS L 2525, a visible light transmittance of at least 50% is measured with respect to a wavelength ranging from 380 to 780 nm in compliance with KS L 2514, and a color difference (ΔE) of less than 4.5 is measured in compliance with ASTM C 1376.
